(19) United States
(12) Patent Application Publication
(10) Pub. No.: US 2014/0354703 A1
(43) Pub. Date: Dec. 4, 2014

(54) ORGANIC LIGHT EMITTING DISPLAY DEVICE AND DRIVING METHOD THEREOF

(71) Applicant: Samsung Display Co., Ltd., Yongin-City (KR)

(72) Inventors: Sang-Myeon HAN, Yongin-City (KR); Baek-Woon LEE, Yongin-City (KR); Kwang-Sub SHIN, Yongin-City (KR)

(73) Assignee: Samsung Display Co., Ltd., Yongin-City (KR)

(21) Appl. No.: 14/046,484

(22) Filed: Oct. 4, 2013

(30) Foreign Application Priority Data
May 31, 2013 (KR) 10-2013-0062621

(51) Int. Cl. G09G 3/32

(52) U.S. Cl. CPC G09G 3/3291
USPC 345/690; 345/83

(57) ABSTRACT

An organic light emitting diode display includes: a display panel including a plurality of pixels; an image processor which receives a plurality of image data, where the image processor generates a scale control variation for each of the image data, and performs a gamma-correction on the image data based on the scale control variation and predetermined gamma curve information to output a plurality of grayscale data; and a power controller which controls a driving voltage supplied to the display panel based on the scale control variation of each of the image data.

This application claims priority to Korean Patent Application No. 10-2013-0062621 filed on May 31, 2013, and all the benefits accruing therefrom under 35 U.S.C. §119, the content of which in its entirety is herein incorporated by reference.

### BACKGROUND

1. Field

Exemplary embodiments of the invention relates to an organic light emitting diode (“OLED”) display and a driving method of the OLED display.

2. Description

An OLED display is a type of flat panel display. The OLED display includes an OLED that generates light by recombination of electrons and holes for the display of images typically has a fast response speed, is simultaneously driven with low power consumption, and has high luminous efficiency, high luminance and wide viewing angle.

The OLED display includes a data driver for transferring data signals to a plurality of data lines, a scan driver for sequentially transferring scan signals to a plurality of scan lines, and a plurality of pixels connected to the scan lines and the data lines. Each of the pixels includes an OLED and a driving transistor for controlling a current amount supplied to the organic light emitting diode. The OLED emits light corresponding to a current flowing through the driving transistor in response to the data signal.

In the OLED display, power consumption may be increased when the current respectively flowing to a plurality of pixels is not limited, and when supplying the driving voltage with a sufficient margin to operate each driving transistor of a plurality of pixels in a saturation region.

### SUMMARY

Exemplary embodiments of the invention provide an organic light emitting diode (“OLED”) display with reduced power consumption by respectively controlling a current respectively flowing to a plurality of pixels and simultaneously a size of the driving voltage, and a driving method thereof.

An exemplary embodiment of an OLED display according to the invention includes: a display panel including a plurality of pixels; an image processor which receives a plurality of image data, where the image processor generates a scale control variation for each of the image data, and performs a gamma-correction on the image data based on the scale control variation and predetermined gamma curve information to output a plurality of grayscale data; and a power controller which controls a driving voltage supplied to the display panel based on the scale control variation of each of the image data.

In an exemplary embodiment, the image processor may include: a frame memory which stores the image data by a frame unit; a gamma corrector which performs the gamma-correction on the image data output from the frame memory based on the gamma curve information; and a scale variation generator which generates a plurality of compensation current scale control variations corresponding to the image data, a plurality of voltage scale variations and a plurality of grayscale scale variations, where the scale control variation may include the compensation current scale control variations, the voltage scale variations and the grayscale scale variations, the compensation current scale may control variations correspond to the image data, respectively, and control a current which flows to each of the pixels, the voltage scale variations control the driving voltage, and the grayscale scale variations may control a gamma value for the gamma-correction.

In an exemplary embodiment, the gamma corrector may expand each bit number of the image data based on the grayscale scale variations and may correct the gamma value of the gamma curve based on the voltage scale variations.

In an exemplary embodiment, the gamma corrector may extract a gamma correction factor corresponding to the voltage scale variations of a current frame and may correct the gamma value into a value of a product of the gamma correction factor and the voltage scale variations.

In an exemplary embodiment, the scale variation generator may include: a detector which may output a plurality of maximum red data, a plurality of maximum green data and a plurality of maximum blue data, each corresponding to the image data, respectively, a current scale variation generator which may generate a plurality of current scale variations and a plurality of overcurrent scale variations based on a load of each of the image data, a distributor which distributes the maximum red data, the maximum green data, the maximum blue data, the current scale variations and the overcurrent scale variations for each of the image data, a plurality of calculation blocks which may calculate the compensation current scale variations, the grayscale scale variations and the voltage scale variations using the maximum red data, the maximum green data, the maximum blue data, the current scale variations and the overcurrent scale variations, which are distributed thereto for each of the image data, and an aligner which may align the compensation current scale variations, the grayscale scale variations and the voltage scale variations for each of the image data to be output in a predetermined sequence.

In an exemplary embodiment, the detector may divide the image data into a plurality of red data, a plurality of green data and a plurality of blue data, and may detect each a maximum grayscale of each of the red data, the green data and the blue data to generate the maximum red data, the maximum green data and the maximum blue data.

In an exemplary embodiment, the current scale variation generator may generate the current scale variations corresponding to the image data based on a predetermined power limitation variation and the load, and may generate the overcurrent scale variations corresponding to the image data based on a predetermined overpower limitation variation and the load, and the overpower limitation variation may have a greater value than the power limitation variation.

In an exemplary embodiment, each of the calculation blocks may generate a corresponding grayscale scale variation of the grayscale scale variations using a corresponding compensation current scale variation of the compensation current scale variations.

In an exemplary embodiment, each of the calculation blocks may calculate a grayscale value by multiplying a corresponding grayscale scale variation of the grayscale scale variations by a corresponding maximum red data, a corresponding maximum green data and a corresponding maximum blue data, respectively, and may generate a maximum value among a red voltage scale variation corresponding to the calculated grayscale value, a green voltage scale variation corresponding to the calculated grayscale value and a blue voltage scale variation corresponding to the calculated grayscale value as a corresponding voltage scale variation of the voltage scale variations.

In an exemplary embodiment, the scale variation generator may further include a timing filter which limits a difference of each of the compensation current scale variation and the voltage scale variation between a previous frame and a current frame for the image data by a predetermined value.

An exemplary embodiment of a method of driving an OLED display according to the invention includes: generating a scale control variation corresponding to a plurality of image data, respectively; performing a gamma-correction on each of the image data based on the scale control variation and predetermined gamma curve information to output a plurality of grayscale data to a data driver of the organic light emitting diode display; and controlling a driving voltage in a power controller of the organic light emitting diode display based on the scale control variation corresponding to the image data, respectively.

In an exemplary embodiment, the generating the scale control variations may include: storing each of the image data by a frame unit; generating a plurality of compensation current scale control variations corresponding to the image data, respectively, where the compensation current scale control variations control a current which flows to each pixel of the organic light emitting diode display; generating a plurality of voltage scale variations which controls the driving voltage; and generating a plurality of grayscale scale variations which controls a gamma value for the gamma-correction.

In an exemplary embodiment, the generating the compensation current scale control variations may include: generating a current scale variation corresponding to each of the image data, respectively, based on a predetermined power limitation variation and a load; generating an overcurrent scale variation corresponding to each of the image data based on an overpower limitation variation having a greater value than the predetermined power limitation variation and the load; and extracting the compensation current scale control variations based on the current scale variation and the overcurrent scale variation.

In an exemplary embodiment, the generating the voltage scale variations may include: dividing the image data into a plurality of red data, a plurality of green data and a plurality of blue data; extracting a maximum grayscale of each of the red data, the green data and the blue data to generate a maximum red data, a maximum green data and a maximum blue data; calculating a grayscale value by multiplying the grayscale scale variations by the maximum red data, the maximum green data and the maximum blue data, respectively; and selecting a maximum value among a red voltage scale variation corresponding to the calculated grayscale value, a green voltage scale variation corresponding to the calculated grayscale value and a blue voltage scale variation corresponding to the calculated grayscale value as the voltage scale variation.

In an exemplary embodiment, the generating the grayscale scale variation may include calculating the grayscale scale variations using the compensation current scale variations.

In an exemplary embodiment, the method may further include limiting difference of each of the compensation current scale variations and the voltage scale variations between a previous frame and a current frame for the image data by a predetermined value.

In an exemplary embodiment, the performing the gamma-correction on each of the image data may include: expanding bit number of each of the image data based on the grayscale scale variations; extracting a gamma correction factor corresponding to the voltage scale variations of a current frame; and correcting a gamma value of a gamma correction curve based on a value of a product of the gamma correction factor and the voltage scale variations.

In such exemplary embodiments of the invention, the current flowing to the pixels and the voltage level of the driving voltage are controlled such that the power consumption is substantially reduced.

In such exemplary embodiments of the invention, the organic light emitting diode display includes the timing filter to effectively prevent the steep luminance change between the previous frame and the current frame of the input image data such that the image quality error such as a flicker is effectively prevented.

In such exemplary embodiments, when sequentially displaying a video stream of different images in a single display device, the timing filter controls each of the difference images independently of each other, thereby effectively preventing the luminance change in a same image of the different images.

### BRIEF DESCRIPTION OF THE DRAWINGS

The above and other features of the invention will become more apparent by describing in detail exemplary embodiments thereof with reference to the attached drawings, in which:

FIG. 1 is a block diagram showing an exemplary embodiment of an organic light emitting diode (“OLED”) display according to the invention;

FIG. 2 is an equivalent circuit diagram showing an exemplary embodiment of a pixel PX according to the invention;

FIG. 3 is a block diagram showing an exemplary embodiment of an image processor 210 shown in FIG. 1;

FIG. 4 is a block diagram showing an exemplary embodiment of a scale variation generator 216 shown in FIG. 3; and

FIG. 5 is a graph of a current scale curve L1 and an overcurrent scale curve L2 of an exemplary embodiment of a lookup table.

### DETAILED DESCRIPTION

The invention will be described more fully hereinafter with reference to the accompanying drawings, in which embodiments of the invention are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms, “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10%, 5% of the stated value.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the claims set forth herein.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

Hereinafter, exemplary embodiments of the invention will be described in further detail with reference to the accompanying drawings.

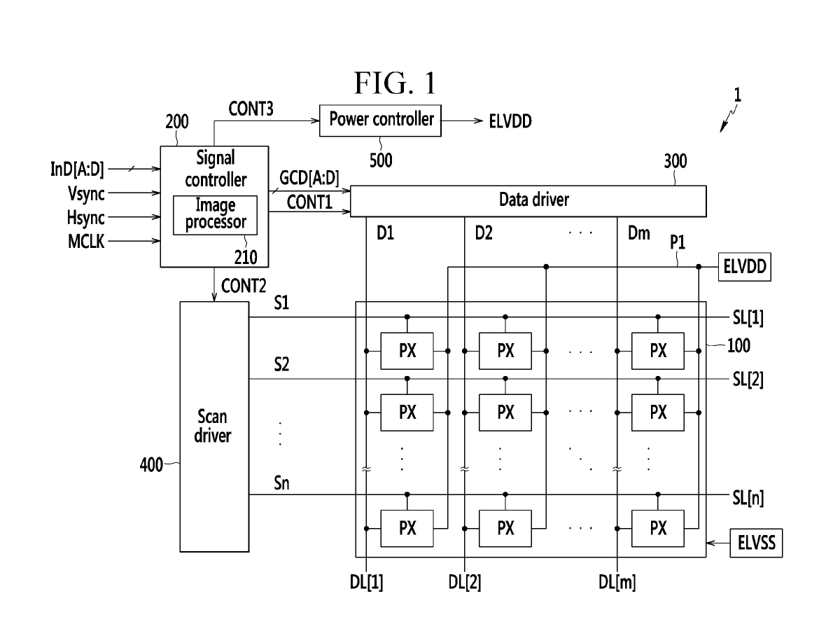

FIG. 1 is a block diagram showing an exemplary embodiment of an organic light emitting diode (“OLED”) display according to the invention.

Referring to FIG. 1, an exemplary embodiment of an OLED display 1 according to the invention includes a display panel 100, a signal controller 200, a data driver 300, a scan driver 400 and a power controller 500. The display panel 100 includes a display area, in which a plurality of pixels PX is disposed. In such an embodiment, a plurality of scan lines SL[1]-SL[n] for transmitting a plurality of scan signals S[1]-S[n] and a plurality of data lines DL[1]-DL[m] for transmitting a plurality of data signals D[1]-D[m] are disposed in the display panel 100. In such an embodiment, a first driving voltage ELVDD and a second driving voltage ELVSS are transmitted to the display panel 100.

In an exemplary embodiment, as shown in FIG. 1, each of the plurality of pixels PX are connected to a corresponding data line of the plurality of data lines DL[1]-DL[m] and a corresponding scan lines of the plurality of scan lines SL[1]-SL[n]. Each of the plurality of pixels PX includes a red subpixel that emits red light, a green subpixel that emits green light, and a blue subpixel that emits blue light.

The signal controller 200 receives a plurality of image data InD[A:D] and a synchronization signal to convert the plurality of image data InD[A:D] into grayscale data GCD[A:D] and to control a function and driving of elements of the display device. Hereinafter, an exemplary embodiment of the invention, where the display panel may display four source images, for example, the source images A, B, C, and D, will now be described for convenience of description, but the invention is not limited thereto.

In an exemplary embodiment, the synchronization signal includes a vertical synchronization signal Vsync, a horizontal synchronization signal Hsync and a main clock signal MCLK. In such an embodiment, the signal controller 200 may divide each of the plurality of image data InD[A:D] by a frame unit based on the vertical synchronization signal Vsync. In such an embodiment, a plurality of image data InD[A:D] may be divided by a scan line unit based on the horizontal synchronization signal Hsync.

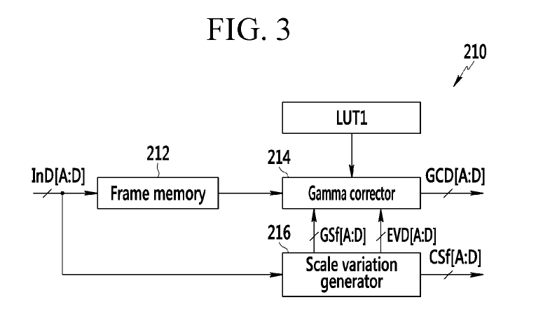

The signal controller 200 includes an image processor 210. The image processor 210 generates a scale control variation for each of the plurality of image data InD[A:D] in every frame. The signal controller 200 performs a gamma-correction on each of the plurality of image data InD[A:D] using the scale control variation, and outputs the gamma-corrected image data as a plurality of grayscale data GCD[A:D]. In an exemplary embodiment, the scale control variation may include a voltage scale variation EVD[A:D], a compensation current scale variation CSf[A:D] and a grayscale scale variation GSf[A:D], as shown in FIG. 3.

The data driver 300 is connected to the plurality of data lines DL[1]-DL[m], and samples and holds the grayscale data GCD[A:D] based on a data control signal CONT1 to generate the plurality of data signals D[1]-D[m]. The data driver 300 transmits the plurality of data signals D[1]-D[m] to the plurality of data lines DL[1]-DL[m], respectively.

In an exemplary embodiment, the scan driver 400 is connected to the plurality of scan lines SL[1]-SL[n], and generates the plurality of scan signals S[1]-S[n] based on the scan control signal CONT2. The scan driver 400 sequentially transmits the plurality of scan signals S[1]-S[n] to the plurality of scan lines SL[1]-SL[n].

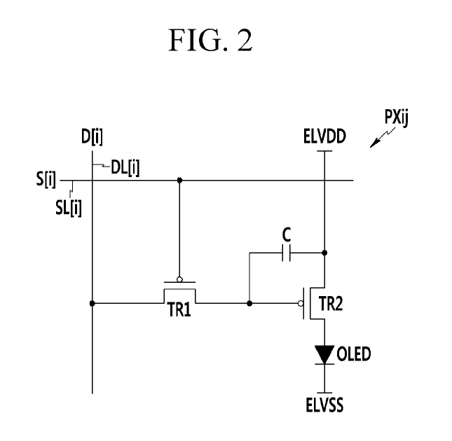

In such an embodiment, the plurality of scan signals S[1]-S[n] are signals to transmit the corresponding data signals to the plurality of pixels PX. The plurality of scan signals S[1]-S[n] may be a combination of a gate-on voltage for turning on a switching transistor (e.g., TR1 shown in FIG. 2) and a gate-off voltage for turning off the switching transistor.

The power controller 500 generates the first and second driving voltages ELVDD and ELVSS (shown in FIG. 2) and controls a voltage level of the first driving voltage ELVDD based on the power source control signal CONT3. In an exemplary embodiment of the invention, the power controller 500 controls a voltage level of the first driving voltage ELVDD, however the invention is not limited thereto. In an alternative exemplary embodiment, a voltage level of the second driving voltage ELVSS may be controlled by the power controller 500.

FIG. 2 is an equivalent circuit diagram showing an exemplary embodiment of a pixel PX according to the invention.

Referring to FIG. 2, the pixel PXij is connected to an i-th scan line SL[i] and a j-th data line DL[j], and the pixel PXij includes a switching transistor TR1, a driving transistor TR2, a capacitor C and an OLED. The switching transistor TR1 includes a gate electrode connected to the i-th scan line SL[i], a source electrode connected to the j-th data line DL[j], and a drain electrode connected to the gate electrode of the driving transistor TR2.

The driving transistor TR2 includes a source electrode connected to the first driving voltage ELVDD supply line, a drain electrode connected to a anode of the red OLED, and a gate electrode to which a data signal is transferred during the turn-on period of the switching transistor TR1.

The capacitor C is connected between the gate electrode and source electrode of the driving transistor TR2. A cathode of the OLED receives the second driving voltage ELVSS. Hereinafter, the operation of such an embodiment of the pixel PXij will be described.

In such an embodiment, the switching transistor TR1 is turned on by a scan signal S[i] having the level of the gate-on voltage. When the switching transistor TR1 is turned on, a data signal D[j] is transmitted to the gate electrode of the driving transistor TR2. The voltage difference between the gate electrode and the source electrode of the driving transistor TR2 is maintained by the capacitor C, and driving current flows to the driving transistor TR2. The OLED emits light based on the driving current.

In FIG. 2, one exemplary embodiment of the pixel PX are shown for convenience of illustration, but the invention is not limited thereto In an alternative exemplary embodiment, the display device may include pixels having various structures.

FIG. 3 is a block diagram showing an exemplary embodiment of an image processor 210 shown in FIG. 1.

Referring to FIG. 3, an exemplary embodiment of the image processor 210 according to the invention includes a frame memory 212, a gamma corrector 214, a scale variation generator 216 and a first lookup table LUT1. In such an embodiment, the plurality of image data InD[A:D] are stored to the frame memory 212 for every frame unit, and are delayed by a predetermined time and then outputted to the gamma corrector 214.

The gamma corrector 214 expands each bit number of the plurality of image data InD[A:D] output from the frame memory 212 based on the grayscale scale variation GSf[A:D] from the scale variation generator 216. In one exemplary embodiment, for example, when the plurality of image data InD[A:D] have 10 bits and a grayscale scale variation GSf[A:D] has 10 bits, the gamma corrector 214 may be expanded to 20 bit data at a maximum. In such an embodiment, the gamma corrector 214 may be selected upper 13 bits among the 20 bits. In an exemplary embodiment of the invention, the display device has 1920×1080 resolution.

The gamma corrector 214 extracts gamma curve information from the first lookup table LUT1 and converts the plurality of expanded image data InD[A:D] into the plurality of grayscale data GCD[A:D], respectively, based on the extracted gamma curve information. In an exemplary embodiment, the gamma corrector 214 correct, e.g., compensate, amends or updates, the gamma curve that is previously stored to the first lookup table LUT1 in real time based on the voltage scale variation EVD[A:D] from the scale variation generator 216. In such an embodiment, the gamma correction factor corresponding to the voltage scale variation EVD[A:D] may be previously stored to the first lookup table LUT1. The gamma corrector 214 extracts the gamma correction factor corresponding to the voltage scale variation EVD[A:D] of a current frame from the first lookup table LUT1, and amends the gamma value corresponding to the gamma curve that is previously stored as a value of a product of the gamma correction factor and the voltage scale variation EVD[A:D]. In such an embodiment, a gamma correction value, the gamma correction factor and the gamma value may satisfy the following Equation 1.

GCf(n)=GC(n)+CA(n)×EVD Equation 1

In Equation 1, GCf(n) denotes a corrected gamma value of an n-th frame, GC(n) denotes the gamma value of the n-th frame, and CA(n) denotes the gamma correction factor of the n-th frame. As in Equation 1, an exemplary embodiment of the invention compensates the gamma curve in real time such that the luminance change due to the change of the first power source voltage ELVDD may be effectively prevented.

The scale variation generator 216 generates the compensation current scale control variation CSf[A:D] corresponding to the plurality of image data InD[A:D], respectively and which controlling each of currents flowing to the plurality of pixels PX, the voltage scale variation EVD[A:D] that controls the first driving voltage ELVDD, and the grayscale scale variation GSf[A:D] that controls the gamma value for gamma-correction of the plurality of image data InD[A:D].

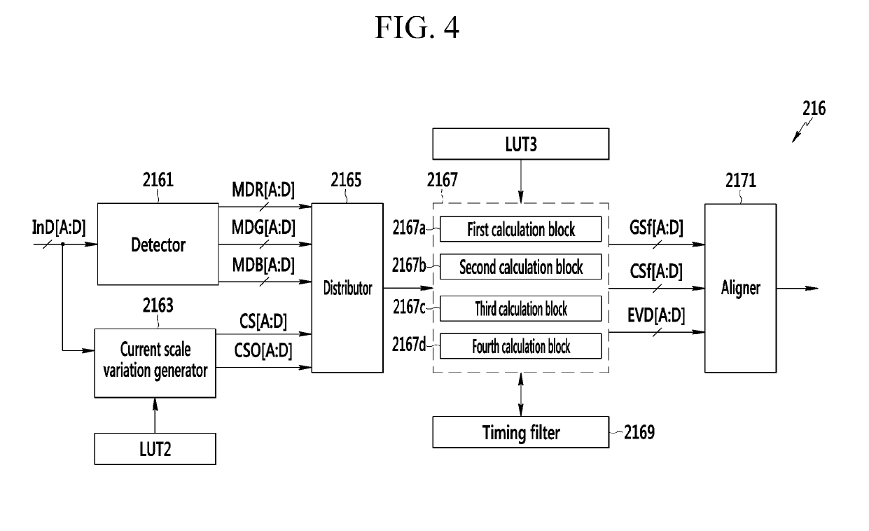

FIG. 4 is a block diagram showing an exemplary embodiment of a scale variation generator 216 shown in FIG. 3.

Referring to FIG. 4, an exemplary embodiment of the scale variation generator 216 according to the invention includes a detector 2161, a current scale variation generator 2163, a distributor 2165, a calculator 2167, a timing filter 2169, an aligner 2171 and second and third lookup tables LUT2 and LUT3.

The detector 2161 divides the plurality of image data InD[A:D] into red data, green data and blue data. The detector 2161 detects a maximum grayscale of each of the red data, the green data and the blue data to output maximum red data MDR[A:D], maximum green data MDG[A:D] and maximum blue data MDB[A:D].

The current scale variation generator 2163 generates a current scale variation CS[A:D] and an overcurrent scale variation CSO[A:D] based on a load of each of the plurality of image data InD[A:D]. Here, the load is a value representing a ratio of the current flowing to the plurality of the pixels PX based on the plurality of image data InD[A:D] with respect to a current flowing to the plurality of the pixels PX during full white light emitting. In such an embodiment, the load is 100% when the current flowing to the plurality of the pixels PX during full white light emitting. In such an embodiment, the current scale variation generator 2163 extracts a power limitation variation from the second lookup table LUT2 and generates the current scale variation CS[A:D] of each of the plurality of image data IND[A:D] based on the power limitation variation and the load. In such an embodiment, the current scale variation, the power limitation variation and the load may satisfy the following Equation 2.

CS=NPC|(load)^{P} Equation 2

In Equation 2, CS denotes the current scale variation, NPC denotes the power limitation variation, which is a constant predetermined by a user and having a value of 0<NPC≦1, P denotes a load coefficient having a value of 0<P≦1. As in Equation 2, when the current scale variation (CS) based on the load is greater than 1, the current scale variation (CS) may be limited by the value of 1. In an exemplary embodiment, the current scale variation (CS) may be expressed by a binary value having an arbitrary digit.

In an exemplary embodiment, the current scale variation generator 2163 extracts a overpower limitation variation from the second lookup table LUT2 and generates a overcurrent scale variation CSO[A:D] of each of the plurality of image data IND[A:D] based on the overpower limitation variation and the load.

The overcurrent scale variation CSO[A:D] may be calculated using Equation 2. In an exemplary embodiment, the overpower limitation variation may be set as a value greater than the power limitation variation. In one exemplary embodiment, for example, when the power limitation variation is set to 25%, the overpower limitation variation may be set to 30%. The overcurrent scale variation CSO[A:D] may be expressed by a binary value having an arbitrary digit.

The power limitation variation (NPC), the overpower limitation variation, and the load coefficient (P) may be stored in the second lookup table LUT2.

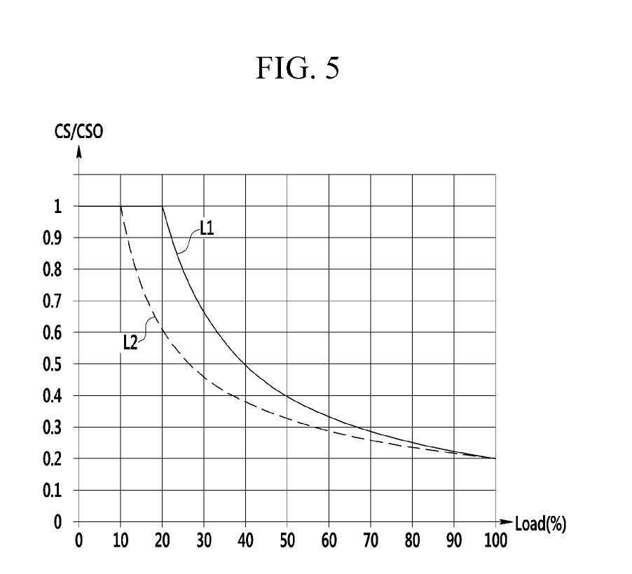

FIG. 5 is a graph showing a current scale curve L1 and an overcurrent scale curve L2 of an exemplary embodiment of a lookup table. As shown in FIG. 5, the second lookup table LUT2 may store a current scale curve L1 corresponding to a graph of the power limitation variation (NPC) versus the load coefficient (P), and a overcurrent scale curve L2 corresponding to a graph of the overpower limitation variation versus the load coefficient (P).

The distributor 2165 distributes the maximum red data MDR[A:D], the maximum green data MDG[A:D], the maximum blue data MDB[A:D], the current scale variation CS[A:D] and the overcurrent scale variation CSO[A:D] for the images A to D, and transmits the maximum red data MDR[A:D], the maximum green data MDG[A:D], the maximum blue data MDB[A:D], the current scale variation CS[A:D] and the overcurrent scale variation CSO[A:D] to each of first to fourth calculation blocks 2167a-2167d of the calculator 2167 in a predetermined order.

The calculator 2167 includes the first to fourth calculation blocks 2167a-2167d corresponding to the images A to D, respectively. The first to fourth calculation blocks 2167a-2167d generate the compensation current scale variation CSf[A:D] using the current scale variation CS[A:D] and/or the overcurrent scale variation CSO[A:D].

The first to fourth calculation blocks 2167a-2167d may detect a difference between the compensation current scale variation CSf[A:D] of the previous frame and the compensation current scale variation CSf[A:D] of the current frame through the timing filter 2169 to control the compensation current scale variation CSf[A:D].

In such an embodiment, if a difference between the compensation current scale variation CSf[A:D] of the previous frame and the compensation current scale variation CSf[A:D] of the current frame is greater than a predetermined current limitation variation, the compensation current scale variation CSf[A:D] of the current frame is limited to a sum of the compensation current scale variation CSf[A:D] of the previous frame and the predetermined current limitation variation according to the following Equation 3.

CSf(n)=CSf(n−1)+d1 Equation 3

In Equation 3, CSf(n) denotes a compensation current scale variation of a n-th frame, CSf(n−1) denotes a compensation current scale variation of a (n−1)-th frame, and d1 denotes the predetermined current limitation variation.

In such an embodiment, the first to fourth calculation blocks 2167a-2167d generate the grayscale scale variation GSf[A:D] using the compensation current scale variation CSf[A:D]. In an exemplary embodiment, when the compensation current scale variation CSf[A:D] is controlled by the timing filter 2169, the grayscale scale variation GSf[A:D] may also be controlled.

In such an embodiment, each of the first to fourth calculation blocks 2167a-2167d calculates the grayscale value that is scaled by multiplying the grayscale scale variation GSf[A:D] by the maximum red data MDR[A:D], the maximum green data MDG[A:D] and the maximum blue data MDB[A:D], respectively. In such an embodiment, a red voltage scale variation, a green voltage scale variation and a blue voltage scale variation, which correspond to the calculated grayscale value, are extracted from the third lookup table LUT3.

Each of the first to fourth calculation blocks 2167a-2167d output a maximum value among the extracted red voltage scale variation, the extracted green voltage scale variation and the extracted blue voltage scale variation as a voltage scale variation EVD[A:D]. The first to fourth calculation blocks 2167a-2167d may detect a difference between the voltage scale variation EVD[A:D] of the previous frame and the voltage scale variation EVD[A:D] of the current frame through the timing filter 2169 to control the voltage scale variation EVD[A:D].

In an exemplary embodiment, if the difference between the voltage scale variation EVD[A:D] of the previous frame and the voltage scale variation EVD[A:D] of the current frame is greater than a predetermined voltage limitation variation, the voltage scale variation EVD[A:D] of the current frame is limited to a sum of the voltage scale variation EVD[A:D] of the previous frame and the predetermined voltage limitation variation according to the following Equation 4.

EVD(n)EVD(n−1)±d2 Equation 4

In Equation 4, EVD(n) denotes the voltage scale variation EVD[A:D] of the n-th frame, EVD(n−1) denotes the voltage scale variation EVD[A:D] of the (n−1)-th frame, and d2 denotes the predetermined voltage limitation variation.

Accordingly, in an exemplary embodiment of the invention, the compensation current scale variation CSf[A:D], the grayscale scale variation GSf[A:D] and the voltage scale variation EVD[A:D] are calculated and distributed for each image A to D. In such an embodiment, current and voltage filter variations (d1 and d2) are applied to the same image regardless of the order in which the image is input, such that a luminance change between different images is effectively prevented.

The aligner 2171 aligns each of the compensation current scale variation CSf[A:D], the grayscale scale variation GSf[A:D] and the voltage scale variation EVD[A:D] according to the predetermined order. In an exemplary embodiment, the aligner 2171 may selectively output the compensation current scale variation CSf[A:D]. In one exemplary embodiment, for example, the aligner 2171 may output the compensation current scale variation CSf[A:D] when performing an image quality improvement operation, e.g., an operation for compensating a light emitting amount that may be deteriorated due to the light emitting time of the pixels PX. In such an embodiment, the aligner 2171 may selectively output a portion of the compensation current scale variation CSf[A:D], the grayscale scale variation GSf[A:D], and the voltage scale variation EVD[A:D] based on the display mode of the plurality of image data InD[A:D].

Hereafter, an operation of an exemplary embodiment of the image processor 210 to display the source images A, B, C and D in a two-dimensional (“2D”) image or a three-dimensional (“3D”) image will be described.

Firstly, the operation of an exemplary embodiment of the image processor 210 when four 2D images, e.g., A, B, C and D images in the 2D mode, are viewed by four users will be described. When A, B, C and D images are viewed by four users in the 2D mode, as shown in Table 1 below, the image data InD[A:D] corresponding to the A image (An), the B image (Bn), the C image (Cn), and the D image (Dn) are transmitted during first to fourth unit frames of the n-th frame, respectively. Here, the unit frame is a period for displaying each of the 2D images, and the unit frame may be 1/240 second.

TABLE 1

| | Input frame | | | |
|---|---|---|---|---|
| | First unit | Second unit | Third unit | Fourth unit |
| | frame | frame | frame | frame |
| Image | An | Bn | Cn | Dn |
| information | | | | |

When the four 2D images A, B, C and D are viewed by four users, the first to fourth calculation blocks 2167a-2167d respectively calculate the compensation current scale variation CSf[A:D], the grayscale scale variation GSf[A:D], and the voltage scale variation EVD[A:D] corresponding to the A image (An), the B image (Bn), the C image (Cn), and the D image (Dn).

In such an embodiment, the aligner 2171 aligns and outputs the compensation current scale variation CSf[A:D], the grayscale scale variation GSf[A:D], and the voltage scale variation EVD[A:D] according to the order of the A image (An), the B image (Bn), the C image (Cn) and the D image (Dn).

Next, the operation of an exemplary embodiment of the image processor 210 when a single 2D image, e.g., A image in the 2D mode, is viewed by one user will be described. When A image is viewed by one user in the 2D mode, as shown in Table 2, the image data corresponding to a first A image (An[1]), the image data corresponding to a second A image (An[2]), the image data corresponding to a third A image (An[3]) and the image data corresponding to a fourth A image (An[4]) are transmitted every first to fourth unit frames of the n-th frame.

TABLE 2

| | Input frame | | | |
|---|---|---|---|---|
| | First unit | Second unit | Third unit | Fourth unit |
| | frame | frame | frame | frame |
| Image | An[1] | An[2] | An[3] | An[4] |
| information | | | | |

In such an embodiment, the A image is transmitted during the first to fourth unit frames, and only one calculation block, e.g., the first calculation block 2167a, among the first to fourth calculation blocks 2167a-2167d is driven. The first calculation block 2167a calculates the compensation current scale variation corresponding to the A image (CSf[An]), the grayscale scale variation corresponding to the A image (GSf[An]), and the voltage scale variation corresponding to the A image (EVD[An]). The aligner 2171 aligns and outputs the compensation current scale variation corresponding to the A image (CSf[An]), the grayscale scaling variation corresponding to the A image (GSf[An]) and the voltage scale variation corresponding to the A image (EVD[An]) according to the order of the first A image (An[1]), the second A image (An[2]), the third A image (An[3]), and the fourth A image (An[4]).

Next, the operation of an exemplary embodiment of the image processor 210 when a single 3D image, e.g., A image in the 3D mode, is viewed by one user will be described. When the A image is viewed by one user in the 3D mode, as shown in Table 3 below, a first left-eye image (A_Ln_1), a first right-eye image (A_Rn_1), a second left-eye image (A_Ln_2), and a second right-eye image (A_Rn_2) are sequentially transmitted during first to fourth unit frames of the n-th frame, respectively.

TABLE 3

| | Input frame | | | |
|---|---|---|---|---|
| | First unit | Second unit | Third unit | Fourth unit |
| | frame | frame | frame | frame |
| Image | A_Ln_1 | A_Rn_1 | A_Ln_2 | A_Rn_2 |
| information | | | | |

In such an embodiment, when a single 3D is viewed by one user, two calculation blocks, e.g., the first and second calculation blocks 2167a and 2167b, among the first to fourth calculation blocks 2167a-2167d are alternately driven. The first calculation block 2167a calculates the compensation current scale variation corresponding to the first and second left-eye images (CSf[A_Ln_1, A_Ln_2]), the grayscale scale variation corresponding to the first and second left-eye images (GSf[A_Ln_1, A_Ln_2]) and the voltage scale variation corresponding to the first and second left-eye images (EVD[A_Ln_1, A_Ln_2]). The second calculation block 2167b calculates the compensation current scale variation corresponding to the first and second right-eye images (CSf[A_Rn_1, A_Rn_2]), the grayscale scale variation corresponding to the first and second right-eye images (GSf[A_Rn_1, A_Rn_2]) and the voltage scale variation corresponding to the first and second right-eye images (EVD[A_Rn_1, A_Rn_2]).

In such an embodiment, the aligner 2171 selects and outputs a minimum value among the compensation current scale variation corresponding to the first left-eye image and right-eye image (CSf[A_Ln_1, A_Rn_1]), and a minimum value among the compensation current scale variation corresponding to the second left-eye image and right-eye (CSf[A_Ln_2, A_Rn_2]).

In such an embodiment, the compensation current scale variations of the left-eye image and the right-eye image becomes substantially the same as each other such that the luminance difference of the first left-eye image and right-eye image having substantially the same grayscale value is effectively prevented. In such an embodiment, the current change amount between the previous frame and the current frame may be limited to be substantially equal to or less than the current limitation variation d1 through the timing filter 2169.

In such an embodiment, the aligner 2171 selects and outputs the maximum value among the voltage scale variation corresponding to the first left-eye image and right-eye image (EVD[A_Ln_1, ARn_1]). Then, the maximum value among the voltage scale variation corresponding to the second left-eye image and right-eye image (EVD[A_Ln_2, A_Rn_2]) is selected and output.

Accordingly, when displaying the left-eye image and the right-eye image, the driving transistor TR2 of each of the plurality of pixels PX is operated in the saturation region such that the color distortion is effectively prevented.

In such an embodiment, the aligner 2171 aligns and outputs the compensation current scale variation, the grayscale scale variation and the voltage scale variation corresponding to the first and second left-eye images and the first and second right-eye images in the order of the first left-eye image (A_Ln_1), the first right-eye image (A_Rn_1), the second left-eye image (A_Ln_2) and the second right-eye image (A_Rn_2), as shown in Table 3.

Next, the operation of an exemplary embodiment of the image processor 210 when two 2D images, e.g., two A images in the 2D mode, are viewed by two users will be described. When two A image are viewed by two users in the 2D mode, as shown in Table 4, the image data corresponding to a first A image (An_1), a first B image (Bn_1), a second A image (An_2) and a second B image (Bn_2) are transmitted during first to fourth unit frames of the n-th frame, respectively.

TABLE 4

| | Input frame | | | |
|---|---|---|---|---|
| | First unit | Second unit | Third unit | Fourth unit |
| | frame | frame | frame | frame |
| Image | An_1 | Bn_1 | An_2 | Bn_2 |
| information | | | | |

In such an embodiment, two calculation blocks, e.g., the first and second calculation blocks 2167a and 2167b, among the first to fourth calculation blocks 2167a-2167d are alternately driven. The first calculation block 2167a calculates the compensation current scale variation corresponding to the first and second A images (CSf[An_1, An_2]), the grayscale scale variation corresponding to the first and second A images (GSf[An_1, An_2]) and the voltage scale variation corresponding to the first and second A images (EVD[An_1, An_2]). The second calculation block 2167b calculates the compensation current scale variation corresponding to the first and second B images (CSf[Bn_1, Bn_2]), the grayscale scale variation corresponding to the first and second B images (GSf[Bn_1, Bn_2]) and the voltage scale variation corresponding to the first and second B images (EVD[Bn_1, Bn_2]).

In such an embodiment, the aligner 2171 aligns and outputs the compensation current scale variation, the grayscale scale variation and the voltage scale variation corresponding to the first and second A images and the first and second B images in the order of the first A image (An_1), the first B image (Bn_1), the second A image (An_2) and the second B image (Bn_2).

Next, the operation of an exemplary embodiment of the image processor 210 when two 3D images, e.g., A and B images in the 3D mode, are viewed by two users will be described. When A and B images are viewed by two users in the 3D mode, as shown in Table 5 below, the left-eye image of the A image (An_L), the right-eye image of the A image (An_R), the left-eye image of the B image (Bn_L), and the right-eye image of the B image (Bn_R) are sequentially transmitted during first to fourth unit frames of the n-th frame, respectively.

TABLE 5

| | Input frame | | | |
|---|---|---|---|---|
| | First unit | Second unit | Third unit | Fourth unit |
| | frame | frame | frame | frame |
| Image | An_L | An_R | Bn_L | Bn_R |
| information | | | | |

In such an embodiment, the compensation current scale variation corresponding to the left-eye and right-eye images of the A image and the left-eye and right-eye images of the B image (CSf[An_L, An_R, Bn_L, Bn_R]), the grayscale scale variation corresponding to the left-eye and right-eye images of the A image and the left-eye and right-eye images of the B image (GSf[An_L, An_R, Bn_L, Bn_R]), and the voltage scale variation corresponding to the left-eye and right-eye images of the A image and the left-eye and right-eye images of the B image (EVD[An_L, An_R, Bn_L, Bn_R]) are calculated through the first to fourth calculation blocks 2167a-2167d.

Then, the aligner 2171 may select and output a minimum value among the compensation current scale variation corresponding to the left-eye image and the right-eye image of the A image (CSf[An_L, An_R]), and a minimum value among the compensation current scale variation corresponding to the left-eye image and the right-eye image of the B image (CSf[Bn_L, Bn_R]).

The aligner 2171 may select and output a maximum value among the voltage scale variation corresponding to the left-eye image and the right-eye image of the A image (EVD[An_L, An_R]), and a maximum value among the voltage scale variation corresponding to the left-eye image and the right-eye image of the B image (EVD[Bn_L, Bn_R]).

Then, the aligner 2171 aligns and outputs the compensation current scale variation, the grayscale scale variation and the voltage scale variation corresponding to the left-eye and right-eye images of the A image and the left-eye and right-eye images of the B image in the order of the left-eye image of the A image (An_L), the right-eye image of the A image (An_R), the left-eye image of the B image (Bn_L), and the right-eye image of the B image (Bn_R).

In an alternative exemplary embodiment, when viewing two 3D images A and B by two users, the image processor 210 may operate differently from an operation of the exemplary embodiment of the image processor 210 described with reference to Table 5. In an exemplary embodiment, as in Table 6 below, the left-eye image of the A image (An_L), the left-eye image of the B image (Bn_L), the right-eye image of the A image (An_R) and the right-eye image of the B image (Bn_R) may be sequentially transmitted during first to fourth unit frames of the n-th frame, respectively.

TABLE 6

| | Input frame | | | |
|---|---|---|---|---|
| | First unit | Second unit | Third unit | Fourth unit |
| | frame | frame | frame | frame |
| Image | An_L | Bn_L | An_R | Bn_R |
| information | | | | |

In such an embodiment, the operation of the image processor 210 is substantially the same as the operation of the exemplary embodiment of the image processor 210 described with reference to Table 5 except that the aligner 2171 aligns and outputs the compensation current scale variation, the grayscale scale variation and the voltage scale variation corresponding to the left-eye and right-eye images of the A image and the left-eye and right-eye images of the B image in the order of the left-eye image of the A image (An_L), the left-eye image of the B image (Bn_L), the right-eye image of the A image (An_R) and the right-eye image of the B image (Bn_R).

Next, the operation of an exemplary embodiment of the image processor 210 when one 3D image, e.g., A image in the 3D mode, and one 2D image, e.g., B image in the 2D mode, are viewed by two users will be described. When A image in the 3D mode and B image in the 2D mode are viewed by two users, as shown in Table 7 below, a left-eye image of the A image (An_L), a first B image (Bn_1), a right-eye image of the A image (An_R) and a second B image (Bn_2) are sequentially transmitted during the first to fourth unit frames of the n-th frame, respectively.

TABLE 7

| | Input frame | | | |
|---|---|---|---|---|
| | First unit | Second unit | Third unit | Fourth unit |
| | frame | frame | frame | frame |
| Image | An_L | Bn_1 | An_R | Bn_2 |
| information | | | | |

In such an embodiment, three different images, that is, the left-eye image of the A image (An_L), the right-eye image of the A image (An_R), and the B image (Bn) are input such that the three calculation blocks, e.g., the first to third calculation blocks, 2167a-2167c, among the first to fourth calculation blocks 2167a-2167d are driven.

The first calculation block 2167a calculates the compensation current scale variation corresponding to the left-eye image of the A image (CSf[An_L]), the grayscale scale variation corresponding to the left-eye image of the A image (GSf[An_L]), and the voltage scale variation corresponding to the left-eye image of the A image (EVD[An_L]).

The second calculation block 2167b calculates the compensation current scale variation corresponding to the first and second B images (CSf[Bn_1, Bn_2]), the grayscale scale variation corresponding to the first and second B images (GSf[Bn_1, Bn_2]) and the voltage scale variation corresponding to the first and second B images (EVD[Bn_1, Bn_2]).

The third calculation block 2167c calculates the compensation current scale variation corresponding to the right-eye image of the A image (CSf[An_R]), the grayscale scale variation corresponding to the right-eye image of the A image (GSf[An_R]) and the voltage scale variation corresponding to the right-eye image of the A image (EVD[An_R]).

Then, the aligner 2171 selects and outputs the minimum value among the compensation current scale variation corresponding to the left-eye image and the right-eye image of the A image (CSf[An_L, An_R]), and the aligner 2171 selects and outputs the maximum value among the voltage scale variation corresponding to the left-eye image and the right-eye image of the A image (EVD[An_L, An_R]).

In such an embodiment, the aligner 2171 selects the compensation current scale variation corresponding to the first and second B images (CSf[Bn_1, Bn_2]), the grayscale scale variation corresponding to the first and second B images (GSf[Bn_1, Bn_2]) and the voltage scale variation corresponding to the first and second B images (EVD[Bn_1, Bn_2]).

Then, the aligner 2171 aligns and outputs the compensation current scale variation, the grayscale scale variation corresponding to the left-eye and right eye A images and the first and second B images, and the voltage scale variation corresponding to the left-eye and right eye A images and the first and second B images in the order of the left-eye image An_L of the A image, the first B image Bn_1, the right-eye image An_R of the A image and the second B image Bn_2.

Next, the operation of an exemplary embodiment of the image processor 210 when one 3D image, e.g., A image in the 3D mode, and two 2D images, e.g., B and C images in the 2D mode, are viewed by three users will be described. When A image in the 3D mode, and B and C images in the 2D mode are viewed by three users, as shown in Table 8 below, the left-eye image of the A image (An_L), the B image (Bn), the right-eye image of the A image (An_R) and the C image (Cn) are sequentially transmitted during first to fourth unit frames of the n-th frame, respectively.

TABLE 8

| | Input frame | | | |
|---|---|---|---|---|
| | First unit | Second unit | Third unit | Fourth unit |
| | frame | frame | frame | frame |
| Image | An_L | Bn | An_R | Cn |
| information | | | | |

In such an embodiment, four different images, e.g., the left-eye image of the A image (An_L), the right-eye image of the A image (An_R), the B image (Bn) and the C image (Cn) are input such that all of the first to fourth calculation blocks 2167a-2167d are all driven.

The first to fourth calculation blocks 2167a-2167d calculate the compensation current scale variation corresponding to the left-eye image of the A image, the B image, the right-eye image of the A image, and the C image (CSf[An_L, Bn, An_R, Cn]), the grayscale scale variation corresponding to the left-eye image of the A image, the B image, the right-eye image of the A image, and the C image (GSf[An_L, Bn, An_R, Cn]) and the voltage scale variation corresponding to the left-eye image of the A image, the B image, the right-eye image of the A image, and the C image (EVD[An_L, Bn, An_R, Cn]).

Then, the aligner 2171 selects and outputs the minimum value among the compensation current scale variation corresponding to the left-eye image and the right-eye image of the A image (CSf[An_L, An_R]), and the aligner 2171 selects and outputs the maximum value among the voltage scale variation corresponding to the left-eye image and the right-eye image of the A image (EVD[An_L, An_R]).

The aligner 2171 then selects the compensation current scale variation corresponding to the B and C images (CSf[Bn, Cn]), the grayscale scale variation corresponding to the B and C images (GSf[Bn, Cn]) and the voltage scale variation corresponding to the B and C images (EVD[Bn, Cn]). Then, the aligner 2171 aligns and outputs the compensation current scale variation corresponding to the left-eye and right-eye images of the A image, the B image and the C image, the grayscale scale variation corresponding to the left-eye and right-eye images of the A image, the B image and the C image, and the voltage scale variation corresponding to the left-eye and right-eye images of the A image, the B image and the C image in the order of the left-eye image of the A image (An_L), the B image (Bn), the right-eye image of the A image (An_R), and the C image (Cn).

In exemplary embodiments, as described above, when sequentially displaying the video stream of the different types of image (e.g., one 3D image and one 2D image) in a single display device, the timing filter 2169 operates substantially the same manner for a same type of image such that the luminance of each type of image may be controlled in dependently from another type of image displayed by the same display device.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. An organic light emitting diode display comprising:
a display panel comprising a plurality of pixels;
an image processor which receives a plurality of image data, wherein the image processor generates a scale control variation for each of the image data, respectively, and performs a gamma-correction on the image data based on the scale control variation and predetermined gamma curve information to output a plurality of grayscale data; and
a power controller which controls a driving voltage supplied to the display panel based on the scale control variation of each of the image data, respectively.

2. The organic light emitting diode display of claim 1, wherein
the image processor comprises:
a frame memory which stores the image data by a frame unit;
a gamma corrector which performs the gamma-correction on the image data output from the frame memory based on the predetermined gamma curve information; and
a scale variation generator which generates a plurality of compensation current scale control variations, a plurality of voltage scale variations and a plurality of grayscale scale variations,
wherein the scale control variation comprises the compensation current scale control variations, the voltage scale variations and the grayscale scale variations,
the compensation current scale control variations correspond to the image data, respectively, and control a current which flows to each of the pixels,
the voltage scale variations control the driving voltage, and
the grayscale scale variations control a gamma value for the gamma-correction.

3. The organic light emitting diode display of claim 2, wherein
the gamma corrector expands each bit number of the image data based the grayscale scale variations, and corrects the gamma value of the predetermined gamma curve based on the voltage scale variations.

4. The organic light emitting diode display of claim 3, wherein
the gamma corrector extracts a gamma correction factor corresponding to the voltage scale variations of a current frame, and corrects the gamma value based on a value of a product of the gamma correction factor and the voltage scale variations of the current frame.

5. The organic light emitting diode display of claim 2, wherein
the scale variation generator comprises:
a detector which outputs a plurality of maximum red data, a plurality of maximum green data and a plurality of maximum blue data, each corresponding to the image data, respectively;
a current scale variation generator which generates a plurality of current scale variations and a plurality of overcurrent scale variations based on a load of each of the image data;
a distributor which distributes the maximum red data, the maximum green data, the maximum blue data, the current scale variations and the overcurrent scale variations for each of the image data;
a plurality of calculation blocks which calculates the compensation current scale variations, the grayscale scale variations and the voltage scale variations using the maximum red data, the maximum green data, the maximum blue data, the current scale variations and the overcurrent scale variations, which are distributed thereto for each of the image data; and
an aligner which aligns the compensation current scale variations, the grayscale scale variations and the voltage scale variations for each of the image data to be output in a predetermined sequence.

6. The organic light emitting diode display of claim 5, wherein
the detector divides the image data into a plurality of red data, a plurality of green data and a plurality of blue data, and detects a maximum grayscale of each of the red data, the green data and the blue data to generate the maximum red data, the maximum green data and the maximum blue data.

7. The organic light emitting diode display of claim 5, wherein
the current scale variation generator generates the current scale variations corresponding to the image data based on a predetermined power limitation variation and the load,
the current scale variation generator generates the overcurrent scale variations corresponding to the image data based on a predetermined overpower limitation variation and the load, and
the predetermined overpower limitation variation has a greater value than the power limitation variation.

8. The organic light emitting diode display of claim 5, wherein
each of the calculation blocks generates a corresponding grayscale scale variation of the grayscale scale variations using a corresponding compensation current scale variation of the compensation current scale variations.

9. The organic light emitting diode display of claim 5, wherein
each of the calculation blocks calculates a grayscale value by multiplying a corresponding grayscale scale variation of the grayscale scale variations by a corresponding maximum red data, a corresponding maximum green data and a corresponding maximum blue data, respectively, and generates a maximum value among a red voltage scale variation corresponding to the calculated grayscale value, a green voltage scale variation corresponding to the calculated grayscale value and a blue voltage scale variation corresponding to the calculated grayscale value as a corresponding voltage scale variation of the voltage scale variations.

10. The organic light emitting diode display of claim 5, wherein
the scale variation generator further comprises a timing filter which limits a difference of each of the compensation current scale variation and the voltage scale variation between a previous frame and a current frame for the image data by a predetermined value.

11. A method of driving an organic light emitting diode display, the method comprising:
generating a scale control variation corresponding to a plurality of image data, respectively;
performing a gamma-correction on each of the image data based on the scale control variation and predetermined gamma curve information to output a plurality of grayscale data to a data driver of the organic light emitting diode display; and
controlling a driving voltage in a power controller of the organic light emitting diode display based on the scale control variation corresponding to the image data, respectively.

12. The method of claim 11, wherein
the generating the scale control variation comprises:
storing each of the image data by a frame unit;
generating a plurality of compensation current scale control variations corresponding to the image data, respectively, wherein the compensation current scale control variations control a current which flows to each pixel of the organic light emitting diode display;
generating a plurality of voltage scale variations which controls the driving voltage; and
generating a plurality of grayscale scale variations which controls a gamma value for the gamma-correction.

13. The method of claim 12, wherein
the generating the compensation current scale control variations comprises:
generating a current scale variation corresponding to each of the image data, respectively, based on a predetermined power limitation variation and a load;
generating an overcurrent scale variation corresponding to each of the image data based on an overpower limitation variation having a greater value than the predetermined power limitation variation and the load; and
extracting the compensation current scale control variations based on the current scale variation and the overcurrent scale variation.

14. The method of claim 12, wherein
the generating the voltage scale variations comprises:
dividing the image data into a plurality of red data, a plurality of green data and a plurality of blue data;
extracting a maximum grayscale of each of the red data, the green data and the blue data to generate a maximum red data, a maximum green data and a maximum blue data;
calculating a grayscale value by multiplying the grayscale scale variations by the maximum red data, the maximum green data and the maximum blue data, respectively; and
selecting a maximum value among a red voltage scale variation corresponding to the calculated grayscale value, a green voltage scale variation corresponding to the calculated grayscale value and a blue voltage scale variation corresponding to the calculated grayscale value as the voltage scale variation.

15. The method of claim 12, wherein
the generating the grayscale scale variations comprises
calculating the grayscale scale variations using the compensation current scale variations.

16. The method of claim 12, further comprising:
limiting difference of each of the compensation current scale variations and the voltage scale variations between a previous frame and a current frame for the image data by a predetermined value.

17. The method of claim 11, wherein
the performing the gamma-correction on each of the image data comprises:
expanding each bit number of the image data based on the grayscale scale variations;
extracting a gamma correction factor corresponding to the voltage scale variations of a current frame; and
correcting a gamma value of a gamma correction curve based on a value of a product of the gamma correction factor and the voltage scale variations.
